(19) United States
(12) Patent Application Publication
(10) Pub. No.: US 2026/0126615 A1
(43) Pub. Date: May 7, 2026

(54) HOLDING DEVICE, OPTICAL ASSEMBLY AND OPTICAL SYSTEM

(71) Applicant: Carl Zeiss SMT GmbH, Oberkochen (DE)

(72) Inventors: Erik LOOPSTRA, Benneveld (NL); Semih OEZTUERK, Schorndorf (DE)

(21) Appl. No.: 19/426,824

(22) Filed: Dec. 19, 2025

Related U.S. Application Data
(63) Continuation of application No. PCT/EP2024/066103, filed on Jun. 11, 2024.

(30) Foreign Application Priority Data
Jun. 20, 2023 (DE) 10 2023 205 748.4

(51) Int. Cl. G02B 7/182; G02B 5/08; G02B 7/18

(52) U.S. Cl. CPC G02B 7/182; G02B 5/0891; G02B 7/181

(57) ABSTRACT

A holding device (28) for a mirror element, in particular for a mirror element (19) for reflecting EUV radiation (16), having a ratio of length (L) to width (B) of more than 2:1, preferably of more than 3:1, particularly preferably of more than 4:1f, or even more than 10:1. The holding device (28) has a mount (29) with a plurality of holding elements (30) laterally clamping the mirror element (19). The holding elements (30) have projecting, resilient portions (32) for the resilient mounting of the mirror element (19). Also disclosed are an optical assembly (27) having such a mirror element (19) and holding device (28) configured to hold the mirror element (19), as well as an EUV lithography system having at least one such optical assembly (27).

### CROSS-REFERENCE TO RELATED APPLICATION

This is a Continuation of International Application PCT/EP2024/066103, which has an international filing date of Jun. 11, 2024, and the disclosure of which is incorporated in its entirety into the present Continuation by reference. This Continuation also claims foreign priority under 35 U.S.C. § 119(a)-(d) to and also incorporates by reference, in its entirety, German Patent Application DE 10 2023 205 748.4 filed Jun. 20, 2023.

### FIELD

The invention relates to a holding device for a mirror element, in particular for a mirror element for reflecting EUV radiation, having a ratio of length to width of more than 2:1, preferably of more than 3:1, particularly preferably of more than 4:1, in particular of more than 10:1. The invention also relates to an optical assembly having such a holding device and such a mirror element. The invention additionally relates to an optical system, in particular an EUV lithography system, comprising at least one such optical assembly.

### BACKGROUND

The EUV lithography system can be an EUV lithography apparatus for exposing a wafer or some other optical arrangement used for EUV lithography, for example an inspection system, e.g. an arrangement for measuring or inspecting masks, wafers or the like that are used in EUV lithography. The EUV lithography system is configured for operation with radiation in the extreme ultraviolet (EUV) wavelength range. In the context of this application, the EUV wavelength range is understood to be a wavelength range between approximately 5 nm and approximately 30 nm. The mirror element described further above, more precisely the substrate of such a mirror element, is typically rectangular or cuboid.

Mirror elements for EUV lithography or for x-ray optics are typically exposed to high radiation loads during operation, whereas this is not the case during breaks in operation. This may lead to temperature fluctuations of the mirror elements on the order of magnitude of e.g. ΔT=±40 K. Temperature fluctuations on the order of magnitude of ΔT=±10 K may also occur during the transport of such mirror elements.

In general, mirror elements, more precisely substrates of mirror elements, for EUV lithography are produced from a so-called zero expansion material, i.e. from a material that has a very low coefficient of linear thermal expansion (referred to as coefficient of thermal expansion, CTE) which has a minimum at a temperature, the so-called zero crossing temperature. The material of the holding device is typically not formed from a zero expansion material, which is why its coefficient of linear thermal expansion differs from the coefficient of linear thermal expansion of the material of the mirror element. The difference between the coefficients of thermal expansion of the substrate of the mirror element and the material of the holding device may lead to impermissible deformations, stresses and possibly breakage.

The holding of mirror elements for EUV lithography apparatuses is typically not effected by accommodating them in a mount, as is generally the case with lens elements, but rather with the aid of a three-point support, in which the mirror element, more precisely the substrate of the mirror element, is supported by a holding device at three support points. However, this kind of holding likewise leads to generally intolerable deformations in mirror elements having a large aspect ratio, i.e. a large difference between their length and their width.

Another problem concerning the holding of such mirror elements, especially if replacement parts are involved, is the fact that the optical assembly consisting of the mirror element and the holding device, in the event that this has high natural frequencies of e.g. more than approx. 100 Hz, may need to absorb a shock load or g-forces of possibly up to 10 g during handling and transport, without being damaged in the process.

### SUMMARY

One object of the invention is to provide a holding device, an optical assembly and an EUV lithography system which enable the holding of mirror elements having a large aspect ratio with the smallest possible deformations and stresses.

This and other objects are achieved according to a first aspect by a holding device of the type mentioned initially which has a mount with a plurality of holding elements for laterally clamping the mirror element.

The holding elements typically have resilient portions projecting beyond the mount for the resilient mounting of the mirror element.

In this aspect of the invention, it is proposed to use a mount for the holding of a generally rectangular mirror element having a large aspect ratio, which mount clamps the mirror element, more precisely the substrate of the mirror element, laterally at a plurality of holding elements, typically at more than ten or more than twenty holding elements, and thus introduces lower local stresses into the mirror element than is the case with a three-point support. For clamping, the holding elements engage on the side surfaces of the mirror element, but the holding elements can also be configured to support the mirror element, i.e. these can clamp the mirror element laterally and also serve as a support for the mirror element.

Lateral clamping of mirror elements for EUV lithography is described in DE102015219671A1, for example. The bridge-type securing elements for holding a mirror element described therein each extend in a radial direction toward the circular mirror element proceeding from the mount. The forces that occur upon a temperature-related change in the distance between the ring-shaped mount and the circular mirror element act in a radial direction and are uniformly absorbed by the securing elements described therein.

This is not the case with the mirror element described here, which has a large aspect ratio: Even with equal distances between adjacent holding elements along the edge or the lateral circumference of the mirror element, the force directions acting on the holding elements upon a change in the distance between the mirror element and the mount are different. Accordingly, the kind of holding described in DE102015219671A1 cannot be straightforwardly transferred to mirror elements having a large aspect ratio.

As an alternative or in addition to lateral clamping, the mirror element in a further aspect of the invention or in a further embodiment can also be supported by a support at the bottom or top side of the mirror element with at least three holding elements.

In one embodiment, the mount is formed from a material having a coefficient of linear thermal expansion which is 2 ppm/K or less, preferably 1 ppm/K or less. As described further above, the material of the mirror element, more precisely the material of the substrate of the mirror element, is often a zero expansion material. In order, upon changes in temperature, to produce as little change as possible in the distance between the mirror element and the mount and ideally to avoid resultant deformations and stresses, it is advantageous in this case if the mount is formed from a material having the lowest possible coefficient of linear thermal expansion.

It is not absolutely necessary for the material of the substrate to be a zero expansion material. Rather, the substrate can be formed from a different material, for example quartz glass or silicon. In this case, too, the ratio of the coefficient of linear thermal expansion of the material of the mount and the material of the substrate of the mirror element should be as close as possible to one, i.e. the coefficients of linear thermal expansion of the two materials should differ as little as possible from one another. In the event that the material of the substrate is not a zero expansion material, the coefficient of linear thermal expansion of the mount is generally greater than specified further above in order to meet this condition.

In a further embodiment, the mount is formed from Invar. Invar is an iron-nickel alloy having a low coefficient of linear thermal expansion of 2 ppm/K or 1 ppm/K or less. Other materials having the lowest possible coefficient of linear thermal expansion can also serve as a mount for the holding device described here. As described further above, materials having a larger coefficient of linear thermal expansion can be used for the mount if the holding device is to serve for holding a substrate that does not consist of a zero expansion material.

In a further embodiment, the holding elements are secured to the mount. For the application described here, it has proved to be advantageous if the holding elements are not formed in one piece with the mount, but rather are secured to the mount via a materially bonded, force-locking and/or positively locking connection. For example, the holding elements can be secured to the mount with the aid of screw connections.

For securing, the holding elements have a securing portion, the bottom side of which is typically secured to the top side of the mount. The securing portion can have two, three or more securing points embodied e.g. in the form of holes at which a respective holding element is screwed to the mount. This enables precise alignment of each holding element. The securing portion can also be secured to the mount in a different way.

In a further embodiment, the holding elements have a portion which projects beyond the mount and which has a securing surface for securing the mirror element. Typically, the holding elements are embodied in one piece and have the projecting portion and the securing portion described further above. The portion projecting beyond the mount typically acts in the manner of a spring for the elastic or resilient mounting of the mirror element on the mount and can be embodied in a bridge-type fashion or otherwise. The projecting portion or possibly the link of the projecting portion to the securing portion can have a very small thickness for the resilient mounting, as is described for example in DE102015219671A1, which is hereby incorporated by reference in its entirety in the content of this application.

At the securing portion, the mirror element, more precisely the substrate of the mirror element, is generally connected to the respective holding element via a materially bonded connection (see below). The securing surfaces typically extend laterally at the holding elements and contact the substrate at the longitudinal side thereof or at the width side thereof. In principle, it is also possible for the securing surfaces to be configured to support the substrate, i.e. the securing surfaces can have a portion that serves as a support for the substrate.

In a development of this embodiment, securing surfaces of holding elements which are mounted along a longitudinal side of the mirror element are arranged in each case at equal distances from one another, and/or securing surfaces of holding elements which are mounted along a width side of the mirror element are arranged in each case at equal distances from one another. This permits the forces acting on the holding elements to be distributed as uniformly as possible. The forces may be caused e.g. by temperature changes, by vibrations or when the substrate or mirror element is initially inserted into the mount. The distances between the securing surfaces of each two adjacent holding elements mounted on the longitudinal side and the securing surfaces of each two adjacent holding elements mounted on the width side are generally of the same magnitude, but this is not absolutely necessary.

In a further embodiment, the holding elements are formed at least in the projecting portion, in particular completely, from a material having a tensile strength of more than 800 MPa. As described further above, the holding elements are used to absorb force. It is also necessary, when inserting the substrate of the mirror element into the mount, to retract the holding elements or their portions projecting beyond the mount, in order to enable non-contact insertion of the substrate into the mount. Retraction of the resilient holding elements is limited by the permissible stresses of the material of the holding elements. The holding elements should therefore be produced from a material which has the highest possible fracture toughness or tensile strength.

Materials having a low coefficient of linear thermal expansion, e.g. Invar, typically have a low tensile strength and are therefore not suitable as materials for the holding elements. In the case of the holding device described here, a functional separation is therefore effected in which the mount is produced from a material having a coefficient of linear thermal expansion adapted to the coefficient of linear thermal expansion of the substrate in order to reduce thermal stresses, and in which the holding elements are produced from a high-strength material having a high tensile strength in order to be able to deflect or retract the holding elements by the necessary amount and in order to absorb forces.

In a further embodiment, the holding elements, at least in the projecting portion, are formed from a tool steel. Tool steels generally have a high tensile strength of 800 MPa or more. For example, the tool steel can be a stainless steel or high-grade steel, e.g. a martensitic chromium steel with nickel addition, in particular X 17 CrNi 16-2, or a high-strength steel such as Stavax ESR (electro-slag refining), for example, which has a tensile strength of more than 1000 MPa.

A further aspect of the invention relates to an optical assembly, comprising: a mirror element having a ratio of length to width which is greater than 2:1, preferably greater than 3:1, particularly preferably greater than 4:1, in particular greater than 10:1, and a holding device for holding the mirror element, the holding device being embodied as described further above.

The mirror element can be embodied for example in the form of a so-called vertical focusing mirror, which focuses incident radiation in a vertical direction. Such mirror elements generally have a large aspect ratio which is within the value range specified above. Such mirror elements are typically designed for reflecting radiation in the EUV wavelength range or for radiation in the x-ray range and can be used e.g. in EUV light sources, in EUV lithography apparatuses or in synchrotron optics. Use in a reflectometer for measuring the reflectivity of a mirror element, e.g. an EUV mirror, is also feasible. The mirror element has a substrate having a surface to which a reflective coating is applied. The reflective coating can be configured for reflecting EUV radiation or optionally for reflecting x-ray radiation. The mirror element is typically operated with grazing incidence. The surface having the reflective coating is generally concavely curved.

In one embodiment, the ratio between a coefficient of linear thermal expansion of the material of the mount and a coefficient of linear thermal expansion of the material of a substrate of the mirror element is between 0.5 and 2.0, preferably between 0.8 and 1.25. As described further above, it is advantageous if the coefficients of linear thermal expansion of the mount and of the substrate of the mirror element are as far as possible of the same order of magnitude, in order to avoid deformations and stresses as far as possible.

In one embodiment, the projecting portions of the holding elements bridge an interspace between a substrate of the mirror element and the mount. The projecting portions of the holding elements bridge an interspace between the inner edge of the mount and the outer edge of the mirror element, more precisely, a respective longitudinal side or width side of the substrate of the mirror element. As described further above, the holding elements or their projecting portions are used for elastically mounting the mirror element on the mount. The stiffness of the projecting portions can be chosen here such that the natural frequencies of the optical assembly are of a desired order of magnitude. High natural frequencies are advantageous in principle from a dynamic standpoint, but in certain situations it can be advantageous if the natural frequencies are not chosen to be too high, e.g. if the optical assembly is a replacement part that needs to be transported.

In a further embodiment, the mirror element, more precisely the substrate of the mirror element, is secured to the securing surfaces of the holding elements through a bond, in particular with an adhesive. As described further above, the securing of the mirror element to the holding elements is typically effected via a materially bonded connection.

In a further embodiment, the mirror element has a substrate composed of a zero expansion material. As described further above, a zero expansion material is understood to be a material having a so-called zero crossing temperature, at which the coefficient of linear thermal expansion of the substrate has a minimum. The zero expansion material can be e.g. titanium-doped quartz glass or a glass ceramic. Alternatively, the substrate of the mirror element can be formed not from a zero expansion material, but rather from a different material, for example quartz glass or silicon.

A further aspect of the invention relates to an optical system, in particular an EUV lithography system, comprising: at least one optical assembly as described further above. Mirror elements having a high aspect ratio can be used for example in the illumination system of an optical system in the form of an EUV lithography apparatus. It is also feasible to use the optical assembly in an optical system only for measuring purposes, for example in a reflectometer for measuring the reflectivity of a mirror, e.g. an EUV mirror. As described further above, the use of optical assemblies is not restricted to EUV lithography systems; rather, the optical assembly can also be used in other optical systems, for example in synchrotron optics.

Further features and advantages of the invention are evident from the following description of exemplary embodiments with reference to the figures of the drawing, which show details salient to the invention, and from the claims. The individual features can be realized in each case individually by themselves or as a plurality in any desired combination in a variant of the invention.

### BRIEF DESCRIPTION OF THE DRAWINGS

Exemplary embodiments are illustrated in the schematic drawing and are explained in the following description. In the figures:

FIG. 1 schematically shows a meridional section through a projection exposure apparatus for EUV projection lithography,

FIG. 2A shows a schematic illustration of a mirror element in the form of a vertical focusing mirror, and

FIG. 2B shows a schematic illustration of an optical assembly comprising the mirror element from FIG. 2A and comprising a holding device having a mount and a plurality of holding elements for laterally clamping the mirror element.

### DETAILED DESCRIPTION

In the following description of the drawings, identical reference signs are used for identical or functionally identical components.

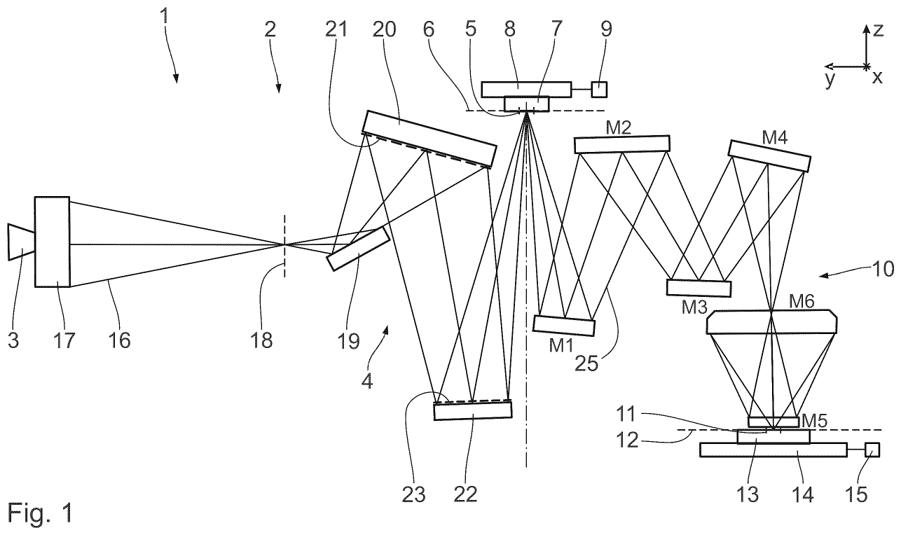

salient constituent parts of an optical arrangement for EUV lithography in the form of a microlithographic projection exposure apparatus 1 are described by way of example below with reference to FIG. 1. The description of the basic setup of the projection exposure apparatus 1 and the constituent parts thereof should not be understood to have a limiting effect.

One embodiment of an illumination system 2 of the projection exposure apparatus 1 has, in addition to a light or radiation source 3, an illumination optical unit 4 for illuminating an object field 5 in an object plane 6. In an alternative embodiment, the light source 3 can also be provided as a module separate from the rest of the illumination system. In this case, the illumination system does not comprise the light source 3.

A reticle 7 arranged in the object field 5 is illuminated. The reticle 7 is held by a reticle holder 8. The reticle holder 8 is displaceable via a reticle displacement drive 9 in particular in a scanning direction.

For explanation purposes, a Cartesian xyz coordinate system is depicted in FIG. 1. The x-direction runs perpendicularly to the plane of the drawing into the latter. The y-direction runs horizontally, and the z-direction runs vertically. The scanning direction runs along the y-direction in FIG. 1. The z-direction runs perpendicularly to the object plane 6.

The projection exposure apparatus 1 comprises a projection system 10. The projection system 10 is used to image the object field 5 into an image field 11 in an image plane 12. A structure on the reticle 7 is imaged onto a light-sensitive layer of a wafer 13 arranged in the region of the image field 11 in the image plane 12. The wafer 13 is held by a wafer holder 14. The wafer holder 14 is displaceable through a wafer displacement drive 15 in particular along the y-direction. The displacement firstly of the reticle 7 through the reticle displacement drive 9 and secondly of the wafer 13 with the wafer displacement drive 15 can be synchronized with one another.

The radiation source 3 is an EUV radiation source. The radiation source 3 emits in particular EUV radiation 16, which is also referred to below as used radiation, illumination radiation or illumination light. The used radiation has in particular a wavelength in the range of between 5 nm and 30 nm. The radiation source 3 can be a plasma source, for example an LPP (Laser Produced Plasma) source or a GDPP (Gas Discharge Produced Plasma) source. It can also be a synchrotron-based radiation source. The radiation source 3 can be a free electron laser (FEL).

The illumination radiation 16 emanating from the radiation source 3 is focused by a collector mirror 17. The collector mirror 17 can be a collector mirror with one or more ellipsoidal and/or hyperboloidal reflection surfaces. The illumination radiation 16 can be incident on the at least one reflection surface of the collector mirror 17 with grazing incidence (GI), i.e. at angles of incidence of greater than 45°, or with normal incidence (NI), i.e. at angles of incidence of less than 45°. The collector mirror 17 can be structured and/or coated, firstly, for optimizing its reflectivity for the used radiation and, secondly, for suppressing extraneous light.

Downstream of the collector mirror 17, the illumination radiation 16 propagates through an intermediate focus in an intermediate focal plane 18. The intermediate focal plane 18 can constitute a separation between a radiation source module, having the radiation source 3 and the collector mirror 17, and the illumination optical unit 4.

The illumination optical unit 4 comprises a deflection mirror 19 and, disposed downstream thereof in the beam path, a first facet mirror 20. The deflection mirror 19 can be a plane deflection mirror or, alternatively, a mirror with a beam-influencing effect that goes beyond the pure deflection effect. Alternatively or additionally, the deflection mirror 19 can be embodied as a spectral filter separating a used light wavelength of the illumination radiation 16 from extraneous light having a wavelength that deviates therefrom. The first facet mirror 20 comprises a multiplicity of individual first facets 21, which are also referred to below as field facets. Only some of these facets 21 are illustrated in FIG. 1 by way of example. In the beam path of the illumination optical unit 4, a second facet mirror 22 is disposed downstream of the first facet mirror 20. The second facet mirror 22 comprises a plurality of second facets 23.

The illumination optical unit 4 thus forms a doubly faceted system. This basic principle is also referred to as a fly's eye condenser (fly's eye integrator). The individual first facets 21 are imaged into the object field 5 with the aid of the second facet mirror 22. The second facet mirror 22 is the last beam-shaping mirror or else actually the last mirror for the illumination radiation 16 in the beam path upstream of the object field 5.

The projection system 10 comprises a plurality of mirrors Mi, which are consecutively numbered in accordance with their arrangement in the beam path of the projection exposure apparatus 1.

In the example illustrated in FIG. 1, the projection system 10 comprises six mirrors M1 to M6. Alternatives with four, eight, ten, twelve or any other number of mirrors Mi are likewise feasible. The penultimate mirror M5 and the last mirror M6 each have a passage opening for the illumination radiation 16. The projection system 10 is a doubly obscured optical unit. The projection optical unit 10 has an image-side numerical aperture which is greater than 0.4 or 0.5 and which can also be greater than 0.6 and which can be for example 0.7 or 0.75.

Just like the mirrors of the illumination optical unit 4, the mirrors Mi can have a highly reflective coating for the illumination radiation 16.

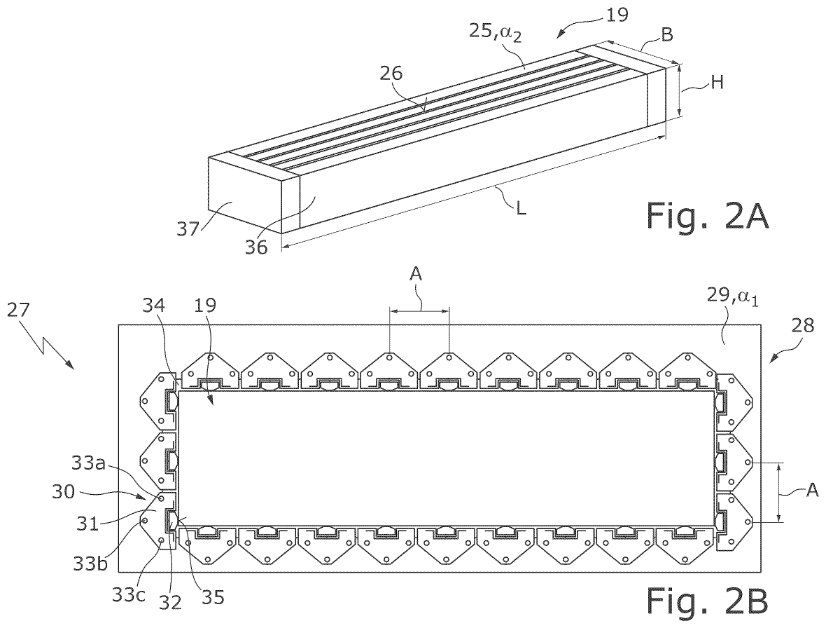

FIG. 2A shows a mirror element 19 in the form of the deflection mirror of the illumination optical unit 4 from FIG. 1, which in this case has an additional beam-influencing effect. The mirror element 19 has a substrate 25 having a concavely curved surface 26, to which a reflective coating—not illustrated pictorially—for reflecting EUV radiation 16 is applied. In the example shown in FIG. 2A, the substrate 25 is cuboid and has a length L of approx. 60 cm, a width B of approx. 13 cm and a height H of approx. 7 cm. The ratio of length L to width B of the substrate 25 of the mirror element 19 is therefore more than 4:1, i.e. the mirror element 19 has a large aspect ratio.

The substrate 25 is formed from a zero expansion material, i.e. a material having a very low coefficient of linear thermal expansion which has a minimum at a temperature, the so-called zero crossing temperature. The substrate 25 can be for example titanium-doped quartz glass or a glass ceramic. The substrate 25 has a coefficient of linear thermal expansion α2 which is less than approx. 0.6 ppm/K in the zero crossing temperature range.

FIG. 2B shows an optical assembly 27 comprising the mirror element 19 from FIG. 2A and a holding device 28 for the mirror element 19. The holding device 28 has a mount 29 in the form of a rectangular frame, which is formed from Invar in the example shown. The mount 29 can also be formed from a different material having the smallest possible coefficient of linear thermal expansion α1, which is 2 ppm/K or less, in the example shown approx. 1 ppm/K or less. The ratio α1/α2 between the coefficient of linear thermal expansion α1 of the material of the mount 29 and the coefficient of linear thermal expansion α2 of the material of the substrate 25 is approx. 1.66 in the example shown.

A plurality of holding elements 30 surrounding the mirror element 19 are secured to the mount 29. The holding elements 30 have a holding portion 31 in the form of a holding block and a substantially triangularly embodied portion 32 projecting beyond the mount 29 in the direction of the mirror element 19. The holding elements 30 are secured to the top side of the mount 29 via the bottom side of the holding portion 31. In the example shown, the securing is effected with the aid of three screws 33a-c, which are arranged at equal distances from one another. The projecting portions 32 of the holding elements 30 bridge an interspace 34 between the mount 29 and the mirror element 19.

The end face of a respective projecting portion 32 is provided with a securing surface 35 for securing the mirror element 19 to the mount 29 of the holding device 28. The mirror element 19, more precisely the substrate 25, is secured to the securing surface 35 of a respective holding element 30 in a materially bonded manner through a bond in the form of an adhesive. The securing surface 35 can optionally also have a portion which serves as a support for supporting the substrate 25 of the mirror element 19.

In the example shown, the holding elements 30 are embodied in one piece and consist of a material having a high fracture toughness or tensile strength of more than 800 MPa. In the example shown, the holding elements 30 are produced from tool steel or high-grade steel in the form of X 17 CrNi 16-2. The holding elements 30 can also be produced from other materials having a high tensile strength, in particular from other tool steels, e.g. from Stavax ESR, which has a tensile strength of more than 1000 MPa.

The projecting portion 32 acts in the manner of a spring element for the elastic mounting of the mirror element 19. For the resilient mounting, the projecting portion 32 can have for example a partial region in which it has a smaller thickness compared with the rest of the projecting portion 32.

As can be discerned in FIG. 2B, securing surfaces 35 of holding elements 30 which are mounted along a longitudinal side 36 of the mirror element 19 are arranged in each case at equal distances A from one another. In addition, securing surfaces 35 of holding elements 30 which are mounted along a width side 37 of the mirror element 19 are arranged in each case at equal distances A from one another. The holding elements 30 themselves are also arranged in a manner distributed uniformly or equidistantly over the circumference of the mirror element 19. In this way, the force absorption is distributed as uniformly as possible among all the holding elements 30.

When the substrate 25 of the mirror element 19 is inserted into the mount 29, the holding elements 30, more precisely their portions 32 projecting beyond the mount 29, are retracted in order to enable non-contact insertion of the substrate 25 into the mount 29. Retraction of the holding elements 30 or the projecting, resilient portions 32 is limited by the permissible stresses of the material of the holding elements 30.

In the case of the holding device 28 shown in FIGS. 2A and 2B, a functional separation is therefore effected such that the mount 29 is produced from a material having a coefficient of linear thermal expansion α1 which as far as possible is of the same magnitude as the coefficient of linear thermal expansion α2 of the substrate 25, in order to reduce thermal stresses, while the holding elements 30 are produced from a material having a high fracture toughness or tensile strength for the force absorption or for the retraction of the holding elements 30 during the initial clamping of the substrate 25 in the mount 29. This makes it possible to reduce deformations and stresses in the holding of the mirror element 19.

The optical assembly 27 described further above can also be used in optical systems other than in an EUV lithography apparatus 1, for example in synchrotron optics or in a reflectometer for measuring the reflectivity of EUV mirrors or of the coatings thereof.

What is claimed is:

1. A holding device for a mirror element, having a ratio of length to width of more than 2:1, the holding device comprising a mount with a plurality of holding elements configured to laterally clamp the mirror element, wherein the holding elements have projecting, resilient portions configured to mount the mirror element.

2. The holding device as claimed in claim 1, wherein the ratio of the length to the width is more than 4:1.

3. The holding device as claimed in claim 2, wherein the ratio of the length to the width is more than 10:1.

4. The holding device as claimed in claim 1, wherein the mount is formed from a material having a coefficient of linear thermal expansion which is 2 ppm/K or less.

5. The holding device as claimed in claim 4, wherein the material has a coefficient of linear thermal expansion which is 1 ppm/K or less.

6. The holding device as claimed in claim 1, wherein the mount is formed from Invar.

7. The holding device as claimed in claim 1, wherein the holding elements are secured to the mount.

8. The holding device as claimed in claim 1, wherein the projecting portions of the holding elements have respective securing surfaces configured to secure the mirror element.

9. The holding device as claimed in claim 8,
wherein the securing surfaces of ones of the holding elements which are mounted along a longitudinal side of the mirror element are each arranged at mutually equal distances, and/or
wherein the securing surfaces of ones of the holding elements which are mounted along a width side of the mirror element are each arranged at mutually equal distances.

10. The holding device as claimed in claim 1, wherein the respective holding elements are formed at least in the projecting portions, respectively, from a material having a tensile strength of more than 800 MPa.

11. The holding device as claimed in claim 10, wherein the holding elements are formed entirely from the material having a tensile strength of more than 800 MPa.

12. The holding device as claimed in claim 1, wherein the holding elements are formed at least in the projecting portion from a tool steel.

13. The holding device as claimed in claim 12, wherein the holding elements are formed completely from a tool steel.

14. An optical assembly, comprising: a mirror element having a ratio of length to width which is greater than 2:1 and a holding device as claimed in claim 1 for holding the mirror element.

15. The optical assembly as claimed in claim 14, wherein the mirror element is configured for reflecting extreme ultraviolet (EUV) radiation.

16. The optical assembly as claimed in claim 14, wherein the ratio of the length to the width is greater than 10:1.

17. The optical assembly as claimed in claim 14, wherein a ratio between a coefficient of linear thermal expansion of a material of the mount and a coefficient of linear thermal expansion of a material of a substrate of the mirror element is between 0.5 and 2.

18. The optical assembly as claimed in claim 17, wherein the ratio between the coefficient of linear thermal expansion of the material of the mount and the coefficient of linear thermal expansion of the material of the substrate of the mirror element is between 0.8 and 1.25.

19. The optical assembly as claimed in claim 14, wherein the projecting portions of the holding elements bridge an interspace between the substrate of the mirror element and the mount.

20. The optical assembly as claimed in claim 14, wherein the substrate of the mirror element is secured to securing surfaces of the holding elements through a materially bonded connection.

21. The optical assembly as claimed in claim 20, wherein the bond is an adhesive.

22. The optical assembly as claimed in claim 14, wherein the mirror element has a substrate composed of a zero expansion material.

23. An optical system, comprising: at least one optical assembly as claimed in claim 14.

24. The optical system as claimed in claim 23 and configured as an EUV lithography system.
